(19) United States
(12) Patent Application Publication
(10) Pub. No.: US 2022/0206196 A1
(43) Pub. Date: Jun. 30, 2022

(54) RETROREFLECTIVE ARTICLE FOR MICROMOBILITY APPLICATIONS

(71) Applicant: 3M INNOVATIVE PROPERTIES COMPANY, St. Paul, MN (US)

(72) Inventors: Shawn T. Brovold, Edina, MN (US); Susannah C. Clear, Hastings, MN (US); Jonathan D. Gandrud, Woodbury, MN (US); Justin M. Johnson, Hudson, WI (US)

(21) Appl. No.: 17/606,901

(22) PCT Filed: May 22, 2020
(86) PCT No.: PCT/IB20/54909

§ 371 Date: Oct. 27, 2021

Related U.S. Application Data
(60) Provisional application No. 62/852,463, filed on May 24, 2019.

(51) Int. Cl. G02B 5/124; G02B 5/128; B60Q 1/26; G02B 5/132

(52) U.S. Cl. CPC G02B 5/124; G02B 5/132; B60Q 1/26; G02B 5/128

(57) ABSTRACT

The present disclosure is directed to retroreflective articles to increase visibility of a vehicle, wherein the retroreflective article comprises one or more retroreflective markings arranged in a given pattern and at least a portion of the article has a curvature.

The present disclosure is directed to retroreflective articles to increase visibility of a vehicle, wherein the retroreflective article comprises two or more retroreflective markings arranged in a given pattern and at least a portion of the article has a curvature.

### BACKGROUND

Micromobility vehicles, such as self-powered scooters, bicycles, motorcycles, etc., are gaining popularity in urban areas as a practical means for transportation for relatively short distances (usually less than 3 miles). However, there are concerns about their safety because micromobility vehicles have a low profile, move at a higher speed with respect to pedestrians but a relatively low speed with respect to larger vehicles such as automobiles and trucks. In general, it can be difficult for road users to see micromobility vehicles, especially at night. This lack of visibility may increase the likelihood of a collision with a motorist or a pedestrian, and even with other micromobility vehicles. The articles of the present disclosure provide additional visibility of the micromobility vehicle potentially increasing the safety of not only the user of the micromobility vehicle, but also those sharing the pathway/sidewalks with the micromobility vehicle.

### SUMMARY

As mentioned above, micromobility vehicles are often used to transport people over relatively short distances. A user of a micromobility vehicle typically rides the vehicle on a roadway, street, pathway or a sidewalk, and generally uses the vehicle in urban or campus settings as a convenient mode of transportation. In many situations, the micromobility vehicle either shares the roadway/street with larger vehicles travelling at relatively high speeds compared to the micromobility vehicle or the lane adjacent to the roadway used by the micromobility vehicle is occupied by such higher-speed larger vehicles. Moreover, sidewalks are often occupied by pedestrians travelling at relatively low speeds compared to the micromobility vehicle. Navigating roadways, streets, paths and/or sidewalks may pose a risk to the safety of the user of the micromobility vehicle, occupants of a larger vehicle, pedestrians, or any other person, pet, or property in proximity to the micromobility vehicle.

One method to maximize the visibility of micromobility vehicles is through strategic application of highly visible material on the available surfaces of the micromobility vehicle, which includes the wheels, and not just the frame. The present disclosure provides an approach for the application of retroreflective articles to micromobility vehicles, preferably on their wheels.

All scientific and technical terms used herein have meanings commonly used in the art unless otherwise specified. The definitions provided herein are to facilitate understanding of certain terms used frequently in this application and are not meant to exclude a reasonable interpretation of those terms in the context of the present disclosure.

Unless otherwise indicated, all numbers in the description and the claims expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviations found in their respective testing measurements.

The recitation of numerical ranges by endpoints includes all numbers subsumed within that range (e.g. a range from 1 to 5 includes, for instance, 1, 1.5, 2, 2.75, 3, 3.80, 4, and 5) and any range within that range.

As used in this specification and the appended claims, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise.

The words “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used in this disclosure, the term “cube corner element” refers to structures capable of retroreflecting electromagnetic radiation. Cube corner elements include truncated cube corner arrays in which the base edges of adjacent cube corner elements are typically coplanar. Other cube corner element structures, described as “full cubes”, typically comprise at least two non-dihedral edges that are not coplanar. Such structures typically exhibit a higher total light return in comparison to truncated cube corner elements. Examples of cube corner elements are described in PCT Application No. WO 2004/081619, which is incorporated herein in its entirety.

As used in this disclosure, the term “retroreflect,” “retroreflected,” or “retroreflection” refers to reflecting a signal back in the direction of the source using a retroreflective item (e.g., an item comprising a corner cube layer). As used herein, the term “retroreflected” is a subset of the term “reflected.”

As used in this disclosure, the term “visible light” refers to electromagnetic radiation having a wavelength in the range from 380 nm to 740 nm.

As used in this disclosure, the term “substantially perpendicular” refers to the relative position of two items, where one item is located at an angle of 90 degrees±5 degrees with respect to the other item.

As used in this disclosure, the term “convex shape” refers to a shape with a surface that curves outward. See, e.g., FIG. 4.

As used in this disclosure, the term “ellipsoid” refers to a three-dimensional shape obtained by rotating an ellipse around one of its axes of symmetry.

As used in this disclosure, two values are “different in magnitude” when one of them is at least 5 percent larger or smaller than the other value.

As used in this disclosure, the term “vehicle” refers to any transportation item having at least one wheel. Examples of vehicles include motorized and non-motorized vehicles, such as automobiles, trucks, bicycles, motorcycles, tricycles, tandem bicycles, unicycle, trailers, etc.

As used in this disclosure, the term “curvature” or “curved” when applied to a line or a surface refers to a line or a surface that deviates from a straight line or a plane as the case may be.

The above summary is merely intended to provide a cursory overview of the subject matter of the present disclosure and is not intended to describe each disclosed embodiment or every implementation of the present invention. The description that follows more particularly exemplifies illustrative embodiments. In several places throughout the application, guidance is provided through lists of examples, which can be used in various combinations. In each instance, the recited list serves only as a representative group and should not be interpreted as an exclusive list.

### BRIEF DESCRIPTION OF THE DRAWINGS

FIG. 1 represents a micromobility vehicle with retroreflective articles of the present disclosure arranged in different patterns.

FIG. 2 represents a wheel having a retroreflective article of the present disclosure having elongate first and second retroreflective markings whose longitudinal axes intersect at an angle of theta 1.

FIG. 3 represents an embodiment of a retroreflective article of the present disclosure where the retroreflective markings are on a substrate at least partially having an ellipsoid shape.

FIG. 4 shows side, rear, and top views of the same embodiment of a wheel with a retroreflective article of the present disclosure.

In the Figures, the gray shading represents retroreflective markings of a red color.

### LIST OF NUMBERED ITEMS IN FIGURES

101—First retroreflective marking
102—Second retroreflective marking
201—First retroreflective marking
202—Second retroreflective marking
301—First retroreflective marking
302—Second retroreflective marking
303—Wheel
401—First retroreflective marking (convex shape)
402—Second retroreflective marking (convex shape)
403—Wheel

### DETAILED DESCRIPTION

For ease of illustration, various embodiments will be discussed in the context of a micromobility vehicle, such as an electric scooter. However, the retroreflective articles of this disclosure can be equally used with other types of motorized and non-motorized vehicles, such as automobiles, trucks, bicycles, motorcycles, tricycles, tandem bicycles, unicycles, trailers, etc.

Generally, the present disclosure is directed to retroreflective articles that comprise two or more retroreflective markings (e.g., first and second retroreflective markings) arranged in a given pattern. Each of those retroreflective markings have either a different optical property that allows to distinguish one marking from the other, or, if they have the same optical property, the magnitude of the value of the property is different for each of the two retroreflective markings.

For instance, in one embodiment, the optical property that distinguishes the two markings may be color. In that case, the first marking may be white and the second marking may be red. It will be understood that any two colors that permit distinguishing between the two markings can be used in the retroreflective article.

Examples of other optical properties that can be used to distinguish the two markings include visible light retroreflectivity at a given angle, linear polarization state, circular polarization state, infrared absorption and reflection at a given incidence angle, ultraviolet absorption and reflection, radar cross section at a given incidence angle and/or a specific radar frequency. In certain preferred embodiments, the two retroreflective markings comprise strips of different color conspicuity tape or other type of retroreflective tape.

In general, each of the first and second retroreflective markings are positioned on a substrate. In some embodiments, the substrate may comprise two separate portions on which each of the first and second markings are positioned. Alternatively, both retroreflective markings may be positioned on the same portion of the substrate.

Each of the first and second retroreflective markings are positioned on the substrate to form a distinct pattern. In some preferred embodiments, the pattern is unique and serves to identify a specific type of micromobility vehicle (e.g., a motorized scooter, or a bicycle, or a motorcycle, etc.). In other instances, a different pattern may serve to identify a micromobility vehicle different from the vehicle identified with a different pattern. Alternatively, the pattern may serve to identify a specific portion of the vehicle, for example the front wheel, or the left side of the vehicle, or even the front wheel on the left side of the vehicle.

In certain embodiments, the pattern may be created by the relative position of the at least two retroreflective markings with respect to each other. In other embodiments, the pattern may be created by using retroreflective markings having a unique shape.

The present disclosure also contemplates a system comprising two or more retroreflective articles, each having a pattern different from the patterns of the other retroreflective articles. In this manner, the retroreflective markings can be applied to different portions of the same vehicle, for example to the front and back wheels of a micromobility vehicle.

Alternatively, two retroreflective articles, each having a pattern different from each other, may be mounted on each side of the same wheel of a two-wheel vehicle. For example, one retroreflective article may be mounted on the right side of the front wheel and the other retroreflective article may be mounted on the left side of the same front wheel of the vehicle.

In yet other embodiments, each retroreflective article is adapted to be mounted on the same side (e.g., either left or right side, (or port and starboard side)) of each of the front and back wheels of a two-wheel vehicle. The system may even comprise four retroreflective articles, each having a pattern different from each of the patterns of the other retroreflective articles in the system, wherein each retroreflective article is adapted to be mounted on each side of each of the two wheels of a two-wheel vehicle.

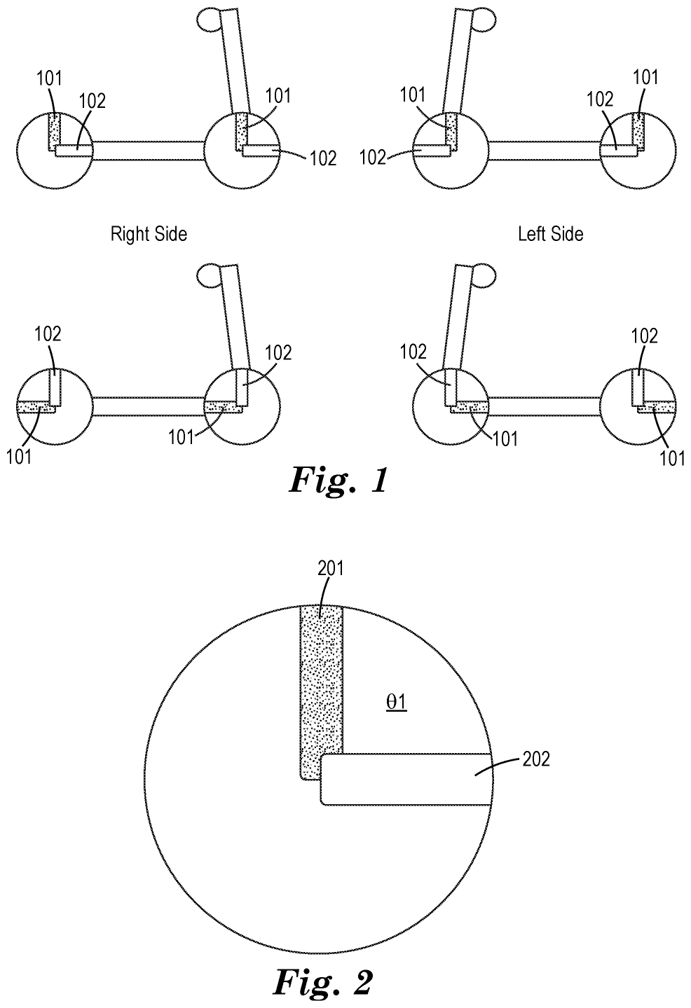

In this regard, FIG. 1 shows a system having retroreflective article with different patterns for the left and right sides of a micromobility vehicle.

FIG. 1 shows an example of how retroreflective articles may be strategically applied to the wheels in a manner that is created for both human and machine detection. In this example, red and white strips are applied to the scooter wheels with a 90-degree offset from one another. The combination of red and white creates a distinctive combination like the conspicuity that is applied to truck trailers. As the wheel turns, the movement of the retroreflector may draw attention from an observer and can be an indication that the wheel and thus the scooter is moving.

In this example the orientations of the unique markings are strategically offset 90 degrees from one another. This allows the observer to determine if the scooter is being viewed from the left or right side.

In this embodiment a white marking is offset 90 degrees clockwise relative to a red marking to indicate the right side; the white marking is offset 90 degrees counterclockwise to a red marking (shown with a shade of gray in the figure) to indicate the left side. This relative orientation also works if the reflective material is continuously wrapped around a wheel spoke.

FIG. 2 shows a schematic representation of a pattern where the two retroreflective markings are separated by an angle theta1. In those embodiments, the pattern comprises an elongate shape first marking having a first longitudinal axis and an elongate second marking having a second longitudinal axis, wherein the first longitudinal axis forms an angle of 90 degrees±5 degrees with the second longitudinal axis. In some embodiments, the angle between the longitudinal axes of the first and second retroreflective markings is in the range from 45±5 degrees to 90±5 degrees, or from 45±5 degrees to 60±5 degrees.

In certain preferred embodiments, at least a portion of the substrate has a curvature (and, therefore, at least a portion of the first or second retroreflective markings have a curvature). The inventors of the present retroreflective articles have found that curved surfaces improve the effectiveness of the retroreflective markings versus a flat surface by increasing the field of view over which the retroreflective markings can retroreflect light.

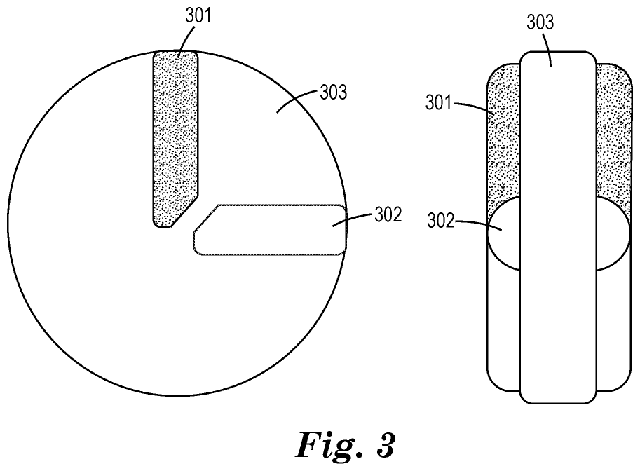

FIG. 3 shows an embodiment in which the two retroreflective markings are either wrapped around the spokes of a wheel or simulate such wrapping. In that embodiment, the shape of the substrate (and, hence, the shape of the retroreflective markings on the substrate) approximates a portion of a cylinder or an ellipsoid.

FIG. 3 shows that the retroreflective markings extend beyond the profile of the wheel/tire so that they are noticeable by an observer directly behind the micromobility vehicle. To avoid upsetting the balancing of the wheel, the wheel may have a symmetric pattern of embossments. In that case, some embossments may have reflective material and some may not. A particular advantage of these types of curved retroreflective markings is that they can be seen not only by an observer situated directly behind, or in front of, the micromobility vehicle but also by an observer looking at the micromobility vehicle from the side. The curved surfaces of those retroreflective markings provide a simple shape upon which the retroreflective markings can be applied and provide effective light return from a larger range of angles.

Therefore, for some micromobility vehicles with wheels having a relatively flat profile (as viewed from the front or rear of the micromobility vehicle), visibility can be improved by attaching retroreflective markings such as those shown in FIG. 3.

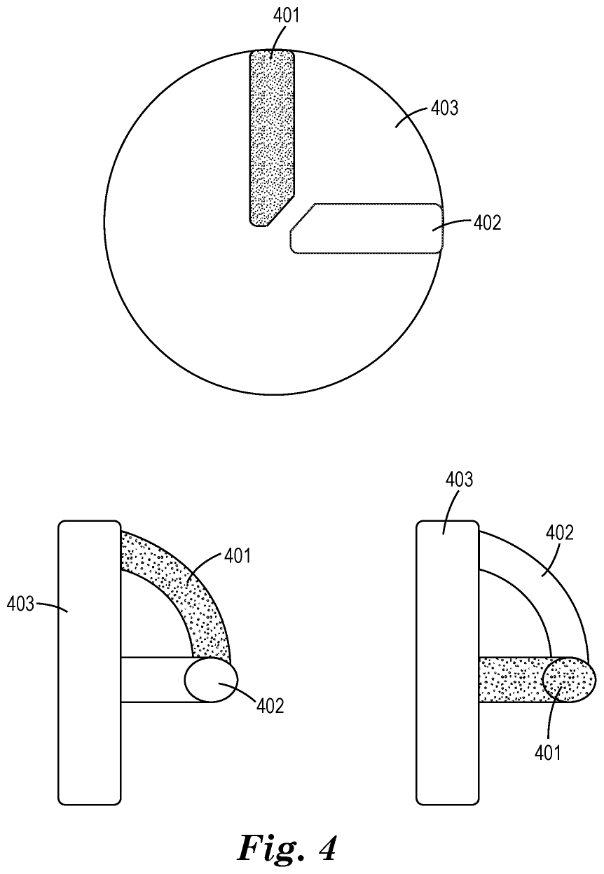

FIG. 4 shows another embodiment having retroreflective markings with curved surfaces. In that embodiment, both retroreflective markings have a convex shape formed by a curved strip of substrate extending radially from the center of the wheel to the outer portion of the wheel. The rear and top view of the same embodiment make it clear that the both retroreflective markings are curved.

In general, although the degree of curvature could affect the retroreflection coefficient for a given incident angle, the fact that the retroreflective markings have a curved shape ensures that the visibility of the micromobility vehicle will be increased with respect to a flat marking. Therefore, the degree of curvature is not considered particularly critical in making the retroreflective articles of this disclosure.

In another embodiment, the retroreflective markings are applied to the majority or even the entire wheel covering to maximize the reflective surface. Just like the spoked wheel design shown in FIG. 3, the embossment could be wider than the tire, so the retroreflective markings are visible from the front or the rear of the micromobility vehicle.

In other embodiments, a cover plate (hubcap-like) having a convex shape could be applied to a wheel (spoked or not). That is, existing flat wheel covers, or spoked wheels, could be retrofitted with a pre-molded convex retroreflective article that fits the shape of the existing wheel to create a rounded surface on the wheel.

As can be surmised from the disclosure above, in certain preferred embodiments, at least a portion of the retroreflective article is capable of rotating about a vehicle axle. That is, the retroreflective article may be attached to a wheel of the vehicle and may rotate when the wheel rotates.

As the wheel rotates, and if illuminated by a source of light, the motion of the wheel can be observed by the change in reflective return from the retroreflective markings. This retroreflection creates a passive flashing effect that will draw the attention of a vehicle operator, thus making the micromobility vehicle more noticeable.

Other embodiments of suitable retroreflective articles include a rounded wheel spoke, wheel coverings with rounded impressions, or even stickers with a raised and rounded shape.

In some embodiments, the retroreflective articles of this disclosure may include other human or machine detectable features, in addition to retroreflecting visible light. For example, the retroreflective articles may include a colored (e.g., yellow, white, etc.) surfaces detectable by a human or machine vision system. That is, at least a portion of the reflective articles may be colored in the human-visible light spectrum. In other embodiments, a combination of opaque and light transmissive colorants may be used. In this way, the retroreflective articles would have effective daytime and nighttime colors. The colored elements may be selected to avoid interference with the functions of the visible retroreflective markings.

In other embodiments, at least a portion of the retroreflective articles may include text, images, or other visual information. Similarly, the reflective articles may include a machine-perceptible surface. For example, at least a portion of the reflective articles may detectable via an infrared camera.

### Exemplary Embodiments

1. A retroreflective article comprising,
   a substrate,
   a first retroreflective marking having a first value, V1, of a first optical property, and
   a second retroreflective marking having a second value, V2, of a second optical property
   wherein the first and second optical properties may be the same or different, wherein, when the first and the second optical properties are the same, the first value is different in magnitude from the second value,
   wherein the first retroreflective marking and the second reflective marking are positioned on the substrate in a first pattern such that the first pattern is associated with a first vehicle, and
   wherein at least a portion of the substrate has a curvature.
2. A retroreflective article comprising,
   a substrate,
   a first retroreflective marking having a first value, V1, of a first optical property, and
   a second retroreflective marking having a second value, V2, of a second optical property
   wherein the first and second optical properties may be the same or different,
   wherein, when the first and the second optical properties are the same, the first value is different in magnitude from the second value,
   wherein the first retroreflective marking and the second reflective marking are positioned on the substrate in a first pattern such that the first pattern is associated with a first vehicle,
   wherein at least a portion of the substrate has a curvature, and
   wherein at least a portion of the article is capable of rotating about a first vehicle axle.
3. A retroreflective article comprising,
   a substrate,
   a first retroreflective marking having a first value, V1, of a first optical property, and
   a second retroreflective marking having a second value, V2, of a second optical property
   wherein the first and second optical properties may be the same or different,
   wherein, when the first and the second optical properties are the same, the first value is different in magnitude from the second value,
   wherein the first retroreflective marking and the second reflective marking are positioned on the substrate in a first pattern such that the first pattern is associated with a first vehicle,
   wherein at least a portion of the substrate has a convex shape, and
   wherein at least a portion of the article is capable of rotating about a vehicle axle.
4. A retroreflective article comprising,
   a substrate,
   a first retroreflective marking having a first value, V1, of a first optical property, and
   a second retroreflective marking having a second value, V2, of a second optical property
   wherein the first and second optical properties may be the same or different,
   wherein, when the first and the second optical properties are the same, the first value is different in magnitude from the second value,
   wherein the first retroreflective marking and the second reflective marking are positioned on the substrate in a first pattern such that the first pattern is associated with a first vehicle,
   wherein at least a portion of the substrate has a curvature,
   wherein the first and second markings is each a retroreflective strip, and the color of the first marking is different from the color of the second marking,
   wherein the pattern comprises an elongate first marking having a first longitudinal axis and an elongate second marking having a second longitudinal axis,
   wherein the first longitudinal axis forms an angle of 90 degrees±5 degrees with the second longitudinal axis, and
   wherein at least a portion of the article is capable of rotating about a vehicle axle.
5. A retroreflective article according to any of the preceding embodiments, wherein the substrate comprises two or more regions.
6. A retroreflective article according to any of the preceding embodiments, wherein the substrate comprises two or more regions and the first marking is positioned on a first region and the second marking is positioned on a second region.
7. A retroreflective article according to any of the preceding embodiments, wherein the substrate comprises one or more regions and both the first marking and the second marking are each positioned on a first region.
8. A retroreflective article according to any of the preceding embodiments, wherein, if the retroreflective articles is affixed to a wheel capable of rotating about a vehicle axle, at least one of the first and second markings has an elongate shape having a longitudinal axis that is substantially perpendicular to the axle axis.
9. A retroreflective article according to any of the preceding embodiments, wherein at least a portion of the article is capable of rotating about a vehicle axle.
10. A retroreflective article according to any of the preceding embodiments, wherein at least a portion of the substrate has a convex shape.
11. A retroreflective article according to any of the preceding embodiments, wherein at least a portion of the substrate has a shape derived from a sphere intersecting with a plane.
12. A retroreflective article according to any of the preceding embodiments, wherein at least a portion of the substrate has a shape derived from an ellipsoid intersecting with a plane.
13. A retroreflective article according to any of the preceding embodiments, wherein at least a portion of the substrate has a shape derived from a cylinder intersecting with a plane.
14. A retroreflective article according to any of the preceding embodiments, wherein the first and second optical properties are each chosen, independently of one another, from visible light retroreflectivity at a given angle, color, linear polarization state, circular polarization state, infrared absorption and reflection at a given incidence angle, ultraviolet absorption and reflection, radar cross section at a given incidence angle and/or a specific frequency.
15. A retroreflective article according to any of the preceding embodiments, wherein the first marking and the second marking are in contact with each other.
16. A retroreflective article according to any of the preceding embodiments, wherein the first marking and the second marking are not in contact with each other.
17. A retroreflective article according to any of the preceding embodiments, wherein the first and second markings each has an elongate shape.
18. A retroreflective article according to any of the preceding embodiments, wherein the first and second markings each has an elongate shape, and each is a strip of visible-light retroreflective material.
19. A retroreflective article according to any of the preceding embodiments, wherein the first and second markings each has an elongate shape, each is a strip of visible-light retroreflective material, and the color of the first marking is different from the color of the second marking.
20. A retroreflective article according to any of the preceding embodiments, wherein the pattern comprises an elongate shape first marking having a first longitudinal axis and an elongate second marking having a second longitudinal axis, wherein the first longitudinal axis forms an angle of 90 degrees±5 degrees with the second longitudinal axis.
21. A retroreflective article according to any of the preceding embodiments, wherein the pattern comprises an elongate first marking having a first longitudinal axis and an elongate second marking having a second longitudinal axis, wherein the first longitudinal axis forms an angle in the range from 45±5 degrees to 90±5 degrees with the second longitudinal axis.
22. A retroreflective article according to any of the preceding embodiments, wherein the pattern comprises an elongate first marking having a first longitudinal axis and an elongate second marking having a second longitudinal axis, wherein the first longitudinal axis forms an angle in the range from 60±5 degrees to 90±5 degrees with the second longitudinal axis.
23. A retroreflective article according to any of the preceding embodiments, wherein the pattern comprises an elongate first marking having a first longitudinal axis and an elongate second marking having a second longitudinal axis, wherein the first longitudinal axis forms an angle in the range from 45±5 degrees to 60±5 degrees with the second longitudinal axis.
24. A retroreflective article according to any of the preceding embodiments, wherein, if the article is affixed to a wheel of a vehicle, the article is dimensioned such that the article is visible to an observer located on the same plane as the plane of the wheel (i.e., the article protrudes beyond the plane of the wheel and is not obstructed by the wheel itself or other portions of the vehicle).
25. A retroreflective article according to any of the preceding embodiments, wherein at least a portion of the first marking is positioned on a portion of the substrate that has a curvature.
26. A retroreflective article according to any of the preceding embodiments, wherein at least a portion of the second marking is positioned on a portion of the substrate that has a curvature.
27. A retroreflective article according to any of the preceding embodiments, wherein at least a portion of the first marking and at least a portion of the second marking are each positioned on a portion of the substrate that has a curvature.
28. A retroreflective article according to any of the preceding embodiments, further comprising at least one attachment system.
29. A retroreflective article according to any of the preceding embodiments, further comprising at least one attachment system configured to affix the retroreflective article to a wheel of a vehicle.
30. A retroreflective article according to any of the preceding embodiments, further comprising at least one attachment system configured to affix the retroreflective article to the wheel of a vehicle, wherein the attachment system is chosen from adhesives, screws, bolts, rivets, pins, nails, staples, fasteners, snap on systems, welding systems, strap(s), zippers, hook-and-loop systems, and magnetic systems.
31. A retroreflective article according to any of the preceding embodiments, further comprising at least one attachment system configured to affix the retroreflective article to one or more spokes on a wheel.
32. A retroreflective article according to any of the preceding embodiments, further comprising at least one attachment system configured to affix the retroreflective article on a rim of a wheel.
33. A retroreflective article according to any of the preceding embodiments, further comprising at least one attachment system adapted to mount the retroreflective article to the center of the wheel.
34. A retroreflective article according to any of the preceding embodiments, further comprising at least one attachment system configured to affix the retroreflective article to a wheel that has a stationary center and a rotating outer portion,
   wherein the attachment system comprises a first and a second portions,
   wherein the first portion is adapted to mount to the stationary center of the wheel and the second portion is adapted to be affixed to the rotating outer portion of the wheel.
35. A retroreflective article according to any of the preceding embodiments, wherein at least one of the first and second markings is printed directly on the substrate.
36. A retroreflective article according to any of the preceding embodiments, wherein at least one of the first and second markings is embossed, casted, and/or molded on the substrate.
37. A retroreflective article according to any of the preceding embodiments, wherein the retroreflective article is dimensioned to fit a wheel of a vehicle chosen from scooter, bicycle, tricycle, tandem bicycle, unicycle, motorcycle, automobile, trailer, and truck.
38. A retroreflective article according to any of the preceding embodiments, wherein the retroreflective article is chosen from a wheel, a rim, a hub cap, a wheel cover, and a placard about a vehicle axle.
39. A system comprising two or more retroreflective articles according to any of the preceding embodiments, each having a pattern different from the patterns of the other retroreflective articles.
40. A system according to any of the preceding embodiments directed to systems, comprising two or more retroreflective articles, each having a pattern different from each of the patterns of the other retroreflective articles in the system, wherein at least one pattern is associated with a given portion of the vehicle.
41. A system according to any of the preceding embodiments directed to systems, comprising two retroreflective articles, each having a pattern different from each other, wherein each retroreflective article is adapted to be mounted on each side of a wheel of a two-wheel vehicle.
42. A system according to any of the preceding embodiments directed to systems, comprising two retroreflective articles, each having a pattern different from each other, wherein each retroreflective article is adapted to be mounted on the same side (e.g., either left or right side, (or port and starboard side)) of each the front and back wheels of a two-wheel vehicle.
43. A system according to any of the preceding embodiments directed to systems, comprising four retroreflective articles, each having a pattern different from each of the patterns of the other retroreflective articles in the system, wherein each retroreflective article is adapted to be mounted on each side of each of the two wheels of a two-wheel vehicle.

1. A retroreflective article comprising,
a substrate;
a first retroreflective marking having a first value, V1, of a first optical property; and
a second retroreflective marking having a second value, V2, of a second optical property,
wherein, when the first and the second optical properties are the same, the first value is different in magnitude from the second value,
wherein the first retroreflective marking and the second reflective marking are positioned on the substrate in a first pattern such that the first pattern is associated with a first vehicle,
wherein at least a portion of the substrate has a convex shape, and
wherein at least a portion of the article is capable of rotating about a vehicle axle.

2. A retroreflective article according to claim 1, wherein the substrate comprises two or more regions and the first marking is positioned on a first region and the second marking is positioned on a second region.

3. A retroreflective article according to claim 1, wherein the substrate comprises one or more regions and both the first marking and the second marking are each positioned on a first region.

4-5. (canceled)

6. A retroreflective article according to claim 1, wherein at least a portion of the substrate has a shape derived from a sphere intersecting with a plane.

7. A retroreflective article according to claim 1, wherein the first and second markings each has an elongate shape, each is a strip of visible-light retroreflective material, and a color of the first marking is different from a color of the second marking.

8. A retroreflective article according to claim 1, wherein the pattern comprises an elongate first marking having a first longitudinal axis and an elongate second marking having a second longitudinal axis, wherein the first longitudinal axis forms an angle in the range from 45±5 degrees to 90±5 degrees with the second longitudinal axis.

9. A retroreflective article according to claim 1, wherein at least a portion of the first marking and at least a portion of the second marking are each positioned on a portion of the substrate that has a curvature.

10. A retroreflective article according to claim 1, further comprising at least one attachment system configured to affix the retroreflective article to a wheel of a vehicle, wherein the attachment system is chosen from adhesives, screws, bolts, rivets, pins, nails, staples, fasteners, snap on systems, welding systems, strap(s), zippers, hook-and-loop systems, and magnetic systems.

11. A retroreflective article according to claim 1, further comprising at least one attachment system configured to affix the retroreflective article to one or more spokes on a wheel.

12. A retroreflective article according to claim 1, further comprising at least one attachment system adapted to mount the retroreflective article to a center of a wheel.

13. A retroreflective article according to claim 1, further comprising at least one attachment system configured to affix the retroreflective article to a wheel that has a stationary center and a rotating outer portion,
wherein the attachment system comprises a first portion and a second portion,
wherein the first portion is adapted to mount to the stationary center of the wheel and the second portion is adapted to be affixed to the rotating outer portion of the wheel.

14. A retroreflective article according to claim 1, wherein the retroreflective article is chosen from a wheel, a rim, a hub cap, a wheel cover, and a placard about a vehicle axle.

15. A system comprising two or more retroreflective articles according to claim 1, each having a pattern different from the patterns of the other retroreflective articles.
